(19) United States
(12) Patent Application Publication
(10) Pub. No.: US 2020/0073951 A1
(43) Pub. Date: Mar. 5, 2020

(54) SMART SEARCH AND HELP SYSTEM

(71) Applicant: SAP SE, Walldorf (DE)

(72) Inventors: Stephan LANGE, St. Leon-Rot (DE); Paul Tanzer, Heidelberg (DE); Simon Hoppermann, Nußloch (DE)

(21) Appl. No.: 16/117,478

(22) Filed: Aug. 30, 2018

(51) Int. Cl. G06F 17/30

(52) U.S. Cl. CPC G06F 17/30011; G06F 17/3053

(57) ABSTRACT

Disclosed herein are system, method, and computer program product embodiments for providing a smart search and help system. An embodiment operates by receiving a search term from a user account. A role associated with the user account is determined. One or more documents of the repository that are associated with the search term are identified. The identified one or more documents are ranked based on both their association with the search term and their association with the role. The ranked one or more documents are returned.

### BACKGROUND

Generally, user assistance and help systems are beneficial to the extent a user can actually find the answers for which the user is searching. However, while different users may have different needs, most help systems return the same answers or documents in response to queries from different users, regardless of their specific needs, based on only the search term entered.

### BRIEF DESCRIPTION OF THE DRAWINGS

The accompanying drawings are incorporated herein and form a part of the specification.

FIG. 1 is a block diagram illustrating example functionality for providing a smart search and help system (SSHS), according to some embodiments.

FIG. 2 is a flowchart illustrating example operations of a SSHS, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a smart search and help system.

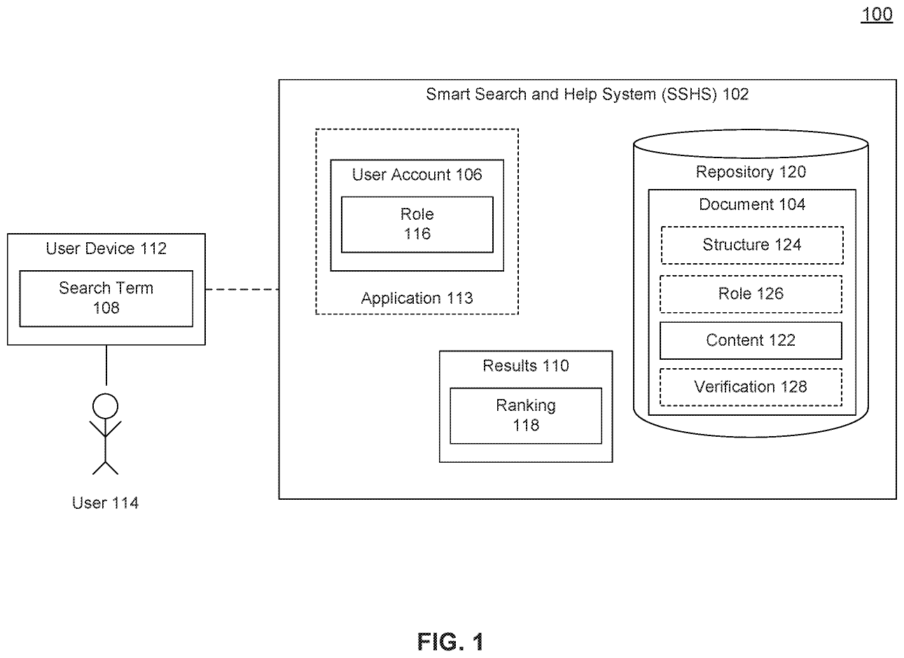

FIG. 1 is a block diagram 100 illustrating example functionality for providing a smart search and help system (SSHS) 102, according to sonic embodiments. SSHS 102 may perform targeted searching based on an entered search term 108, the context of documents 104 as they relate to each other, the search term 108, an application 113, and/or user account information 106 associated with the search, as well as other criteria that would be apparent to persons skilled in the relevant art(s) based on the teachings contained herein. SSHS 102 may produce a different set of results 110 for different users 114 who perform a search using the same search term 108, based on the each user's own unique user account information 106.

In an embodiment, SSHS 102 may be paired with a particular application 113 and provide improved or targeted searching functionality within the context of the application 113. For example, a user may request help in using application 113, and SSHS 102 may provide an improved searching capability for the help function across one or more applications 113, returning unique results for each search query.

SSHS 102 may search and/or score the available files or documents 104 of a repository 120 of files associated with application 113, based on the search term 108 received from a user device 112 (on which application 113 may be operating). Application 113 may include an app, or cloud or web-based program. SSHS 102 may provide search results 110 in different areas or with regard to different types of applications 113, such as human resources (HR), financial planning, project management, business, sales, and travel.

Search term 108 may be a question, phrase, or any set of one or more words or other objects (such as images, video clips, sounds, etc.) about which user 114 is requesting information. In an embodiment, search term 108 may identify, may be associated with, or may be received from a particular application 113. Based on the application 113, SSHS 102 may identify corresponding repository 120 or set of documents 104 to search. For example, SSHS 102 may process a search term 108 from an HR application 113 against a different set of documents 104 relative to a search term 108 from a financial planning application 113.

In an embodiment, search term 108 may include a preamble portion and a substance portion. An example search term 108 may be “How can I create a sales order?” SSHS 102 may determine that “How can I” is the preamble portion, and “create a sales order” is the substance portion of the search term 108.

SSHS 102 may use the preamble portion of a search term to limit the scope of documents 104 that are being searched, excluding or including particular documents 104 or other data objects from repository. For example, “How can I” is an example pattern of a preamble that may be answered using user assistance content 122 or a tutorial file, video, or document 104. “What is” is another example preamble pattern that may also relate to user assistance content or to a terminology database 104. Once a set of documents 104 is identified, SSHS 102 may then use the substance portion to search or score the identified documents 104.

In an embodiment, SSHS 102 may use the preamble portion of search term 108 to determine which agent, or search system is going to be used to identify results 110. For example, tutorial documents 104 may be searched by a first search agent or process that is configured to search the structure of tutorial documents, while a terminology database 104 may be searched by a second agent or process. This division of labor may save computing cycles by having specialized searches, rather than having one general search agent perform all the searches and thus causing delays. The individual search agents may then return results to a managing search agent which may assemble the results 110.

SSHS 102 may receive search term 108 from a user device 112. User device 112 may include a mobile device, laptop, desktop, smart television, or other computing device. A user 114 may be operating user device 112 and may request help performing a particular function or finding content identified by search term 108. As noted above, the search term 108 may be associated with an application 113 operating on user device 112.

In an embodiment, user 114 or user device 112 may be associated with a user account 106. User account 106 may be a profile of information about a particular user 114. The user account information 116 may include name, age, address, years of employment or service, education, viewing preferences or history, purchases, viewed items, friends, social media handles, credit history, and other account or personnel information.

In an embodiment, user account 106 may include role information 116. Role 116 may indicate a user's position within or relative to an organization. Example roles 116 may be customer, client, supplier, accountant, salesperson, human resources representative, chief executive officer, manager, personal trainer, intern, assistant, product manager, etc.

In an embodiment, a particular user 114 (e.g., user account 116) may be associated with multiple or different roles 116. SSHS 102 may return results associated with some or all the roles 116, or may request user 114 to confirm with which role 116 the search term 108 is associated.

In an embodiment, the role 116 may correspond to a particular set of documents 104 from repository 120. The role 116 may enable SSHS 102 to limit the scope of documents 104 to be searched. For example, SSHS 102 may receive the search term 108 “vacation time” from an engineer 116 and an HR representative 116.

SSHS 102 may classify the engineer as an employee, and identify a set of documents 104 that provide information about employee vacation time. The results 110 for the engineer may include search results from an employee handbook indication vacation policy and how much vacation time an employee receives per year.

However, for the HR representative, SSHS 102 may identify a set of documents that are specific to HR personnel, covering topics such as changing an employee's available vacation time, or how to look up the employee's vacation time in an HR system. The search may exclude general employee handbook type documents 104. In another embodiment however, the results 110 may include both the results from the employee handbook and results from an HR representative tutorial that indicates how an HR system 113 may be searched to find out how much vacation time a particular has remaining.

However, SSHS 102 may avoid searching or scoring the FIR representative tutorial in responding to the engineer 116. This may enable SSHS 102 to perform faster searching for the engineer based on the role 116 information, and SSHS 102 may produce a first set of results 110 for the engineer 116, and a second set of different results 110 for the HR representative (role 116) entering the same term 108.

In an embodiment, SSHS 102 may use role 116 and other account information 106 to adjust the ranking of documents in search results 110. For example, for the HR representative, the HR-specific search results may be ranked higher than the employee handbook results.

Document 104 may include any multimedia content (video, audio, and/or written) that includes content 122 and/or metadata that may be searched and/or used to score the document 104 (relative to the search term 108). Documents 104 may include different file types from different programs such as word processing files, spreadsheets, audio files, website and hypertext markup language (HTML) documents, and web-based or locally stored videos.

Repository 120 may include a database or other structured or searchable set of documents 104, including web-based documents such as websites and online videos or other data streams. In an embodiment, repository 120 may include a searchable index that may enable SSHS 102 to find documents 104 relevant for search term 108 and/or user account 106 faster (consuming fewer processing resources). In an embodiment, the documents 104 may include various information or metadata which may be available for indexing or evaluation, including content 122, structure 124, role 126, and verification 128.

Content 122 may include the actual video, audio, or text of a particular document or file. In an embodiment, portions of content 122 (e.g., such as text-based content) may be searchable. The search results 110 may include links to the content 112 of documents 104.

Structure 124 may indicate the different parts of document that may exist 104, which may include content 122 and/or metadata. For example, a text-document may include a title, sub-titles, abstract, author, date created, date modified, application 113, images, text associated with images, headers, etc. Each portion of structure 124 may have its own relative weight in determining the value or score of a document 104 as it relates to search term 108.

For example, SSHS 102 may score two documents 104 that include a search term 108 differently based on where within the structure 124 of each relative document 104, the search term 108 was identified. Each structural element of a file or document 104 may have its own priority or weight assigned by SSHS 102. For example, a first document 104 that includes search term 108 in its title may be scored or ranked higher than a second document 104 that includes search term 108 once in a middle paragraph.

In an embodiment, the frequency of how many times search term 108 is identified in a particular document 104 may affect its score. For example, a document 104 that includes a search term 108 multiple times may have a greater score than a document 104 that only includes the search term once.

In an embodiment, search term 108 may include multiple words. SSHS 102 may determine a distance between the different words in the document 104, which may affect the document's score. The closer two words of a search term 108 are within the content 122 of a document 104, the higher the document's score. For example, a document that includes the terms “maternity” and “leave” right next to each other may be scored higher than a document that includes the same terms separated by a paragraph, for a search term “maternity leave.”

Role 126 may indicate one or more roles 116 with which a particular document 104 corresponds. For example, a user's manual (104) for an HR application 113 may include metadata indicating that role 126 is an HR administrator (e.g., 116). In an embodiment, SSHS 102 may use role 126 to identify which documents are relevant to a particular role 116, and may search those documents 104. Or, for example, SSHS 102 may use a match between role 116 and 126 to rank a first document higher than a second document in search results 110.

In an embodiment, certain documents 104 may include confidential or privileged information that a user 114 needs authorization or clearance to access. In other words, such information may be only accessible to particular roles 126. As such, role 126 may be restrictive and prevent certain roles 116 from accessing a particular document 104. For example, an employee who is not in an HR role may not have authorization to receive results from documents 104 with an HR role 126 designation. Or, for example, role 126 may designate a particular list of one or more roles 116 that may access document 104 as part of results 110.

Verification 128 may be an indicator of a pre-established or predefined relationship between a particular search term 108, user account 106, or application 113 and a document 104. Verification 128 may include one or more words, terms, or phrases against which SSHS 102 compares search term 108. If search term 108 is verified (e.g., identified in the list of verified terms 128), SSHS 102 may determine a pre-generated score for the document 104 relative to search term 108 (without searching the document again), increase the score of the document 104, rank the verified document higher in results 110, provide a verified document indicator in search results 110, or only search verified documents 104 (if any exist), thus limiting the scope of how many documents 104 are searched.

For example, a user's manual 104 for operating a sound system device known as the Kaboom, may include a verification 128 for the search term “Kaboom.” Then, for example, if the search term 128 “Kaboom” is received, the Kaboom user's manual may be included in the results 110. SSHS 102 may then return the user's manual ahead of any other results 110, or instead of searching any other documents 104. However, the Kaboom user's manual may still be accessible to other unverified search terms 108, such as “sound system.”

In an embodiment, SSHS 102 may identify one or more phrases or words that are semantically similar to search term 108, and perform a search on both search term 108 and its similar phrases. For example, for the search term “leave,” SSHS 102 may identify semantically similar terms “absence,” and “vacation.”

In an embodiment, SSHS 102 may identify or include an index or list of other words or phrases that are often associated with the search term 108. For example, based on previous searches, SSHS 102 may determine that the terms “sick,” and “family” are often searched with “leave.” SSHS 102 may then search the terms “leave,” “sick leave,” and “family leave,” or may prompt the user 114 to verify or identify on which terms the user 114 wishes to perform a search.

In generating results 110, SSHS 102 may calculate vectors for terms, words, phrases, paragraphs, and documents/files. A vector may be a numeric interpretation or expression of one or more words. In an embodiment, the closer the vector or score of two words, the more similar SSHS 102 interprets those words as being. For example, the vector for the words “leave,” “absence,” and “vacation” may be similar.

In an embodiment, SSHS 102 may calculate a vector for a particular phrase (one or more words) as follows:

$$v ( phrase ) = normalize ( {\sum }_{word} TFIDF ( word ) * v ( word ) )$$

The vector of a particular phrase, v(phrase) may be the average or weighted average of the vectors of the words in the phrase. In an embodiment, the vector of a particular word v(word) may be normalized, such that the length of the vector is 1. The idea is that vector of the phrase represents the semantics of the phrase by calculating the weighted average of the semantics of each word.

TFIDF (term frequency inverse document frequency) is a measure or weight that indicates how often the word appears in the term versus how often it occurs in all documents. In an embodiment, the more often a word appears, the lower its relative TFIDF or weight. This may ensure that words that generally occur very often, such as “have” or “for” have a lesser weight than words that occur with less frequency, such as “maternity.”

In an embodiment, SSHS 102 may multiply a vector of a word that occurs in the phase with TFIDF(word), SSHS 102 may then normalize the sum, so that the length of the vector is 1 again.

As described above, a document 104 may include a hierarchy or structure 120 of content which may be utilized by SSHS 102 in performing a search. For example, a company may have a variety of products, for which there are multiple guides. Each guide may contain multiple topics, which include various sections with a header and paragraphs. SSHS 102 may generate or compute hierarchy sensitive vectors (hsv), based on the structure 102, such as:

$$hsv ( product ) = v ( productTitle )$$

$$hsv ( guide ) = \frac{{w}_{g 1} * v ( guideTitle ) + {w}_{g 2} * hsv ( product )}{{w}_{g 1} + {w}_{g 2}}$$

$$hsv ( topic ) = \frac{{w}_{t 1} * v ( topicTitle ) + {w}_{t 2} * v ( topicAbstract ) + {w}_{t 3} * hsv ( guide )}{{w}_{t 1} + {w}_{t 2} + {w}_{t 3}}$$

$$hsv ( topicParagraph ) = \frac{{w}_{p 1} * v ( paragraph ) + {w}_{p 2} * hsv ( topic )}{{w}_{p 1} + {w}_{p 2}} \\$$

A first vector may be computed based on the title or name of a particular product or application 113. For example, if the search term 108 is included in the name of a particular list of products (such as “Kaboom”), then the high sensitivity vector may be the vector of the title or name of the product. In some embodiments:
The hierarchy sensitive vector of a guide or user's manual is the weighted average of the vector of the guide's title and the hierarchy sensitive vector of the product.
The hierarchy sensitive vector of a topic is the weighted average of the vector of the topic's title, topic's abstract and the hierarchy sensitive vector of the guide.
The hierarchy sensitive vector of a topic paragraph is the weighted average of the vector of the paragraph and the hierarchy sensitive vector of the topic.
The weights w_{g1}, w_{g2}, wₜ₁, wₜ₂, wₜ₃, wₚ₁ and wₚ₂ are configurable which allows SSHS 102 to express how strong hierarchically leading elements may impact the hierarchy sensitive vector of lower level elements. In an embodiment, the weights may be set to 1.0.

In an embodiment, after calculating the hsv vectors and the vector of the search term 108, SSHS 102 may calculate a cosine similarity of the hsv (e.g., for various documents 104) and the search term vector. Cosine similarity may be a measure of similarity between two non-zero vectors. In an embodiment, identical words may have a cosine similarity of 1, similar, but not identical words have cosine similarity less than 1 but greater than 0. In another embodiment, cosine similarity may range from 1 to −1.

$${Score}_{a} = {\sum }_{SearchTermWord} {max}_{DocumentWord} cosineSimilarity ( SearchTermWord , DocumentWord )$$

In an embodiment, the score may be normalized so that the maximum score is 1.

$${NormalizedScore}_{a} = \frac{{Score}_{a}}{NumSearchTermWords}$$

As described above, user account information 106 may include all kinds of contextual or usage information about the user 114 that can be used for tailoring the behavior of the digital assistant to the particular needs of the individual users. Examples of user context information may include the history of roles 116 that the user had in a company, the applications 113 the user is working with, the questions the user had in the past, and the answers that helped the user in the past. SSHS 102 may calculate a score between 0.0 and 1.0, where this score is greater the better the search result fits to the user scope.

In an embodiment, a feature score (of different portions of the document 104, as identified by structure 120) may be used for the ranking 118 of the search results 110. As noted above, each file or document portion may include its own portion or feature weight. Different feature scores may be configurable by a user or other administrator. The total score is then used for ranking 118 the search results (e.g., in descending order). In some embodiments, the total score, indicating where in a particular document a search term 108 is located, can then be calculated as follows:

$$totalScore = {\sum }_{featureScore} {w}_{featureScore} * featureScore$$

In an embodiment, SSHS 102 may pre-calculate (or receive pre-calculated) hsv of the paragraphs and other documents portions for cached documents. SSHS 102 may perform a first search based on the high sensitivity vectors (hsv), to produce an initial set of documents 104 based, at least in part or primarily on the pre-calculated hsv values for the documents 104. Pre-calculating the hsv values, prior to receive a search request, may enable SSHS 102 generate results 110 in less time and using fewer resources than if hsv was not pre-calculated.

In an embodiment, SSHS 102 may then perform a ranking of the initial set of documents 104 (e.g., generated based on the hsv values). For example, SSHS 102 may receive a request to return only the 100 best documents 104 as part of results 110. However the initial hsv search may have returned 1000 documents 104, from a repository of one million documents. SSHS 102 may rank the 1000 initial documents 104 (rather than the entire repository 120 of one million documents) based on other features, which may require more computing cycles to compute (relative to the hsv).

Some example other features include, but are not limited to: identifying an exactly matching search term 108, determining the distance between the words of the search term 108 in a document 104, determining how frequently the search term 108 is used in a document 104, measuring a correspondence between the document 104 or paragraph where search term 108 is against a determined user context or intent, and measuring of how closely the document 104 is associated with a relative application 113 associated with the search term 108.

In an embodiment, SSHS 102 may return at least three different types of results 110 or answer types: direct answers, close answers, and document answers.

Direct answers may be when SSHS 102 generates a direct answer to a user question with strong confidence (e.g., or cosine similarity). In an embodiment, SSHS 102 may be preconfigured to answer commonly asked questions 108 from a user 114. An example may be, “how many sick days do I get?” To which SSHS 102 may provide the reply “An employee gets 10 sick days per year” and include a link to the employee guidebook.

With close answers, SSHS 102 may provide a link to a document 104 plus the content of a specific paragraph that may help the user 114. This may be determined, for example, based on the similarity between the vector of a search term 108 and a vector of a document 104. In an embodiment, a user 114 may be provided multiple results 110 and may decide which documents 104 are helpful.

With document answers, SSHS 102 may provide links to documents, when the similarity between the vectors of the documents 104 and the search term 108 is low or below a similarity threshold. Results 110 may include the title and the first words the document starts with in order to give the user further hints whether the document would help for the question.

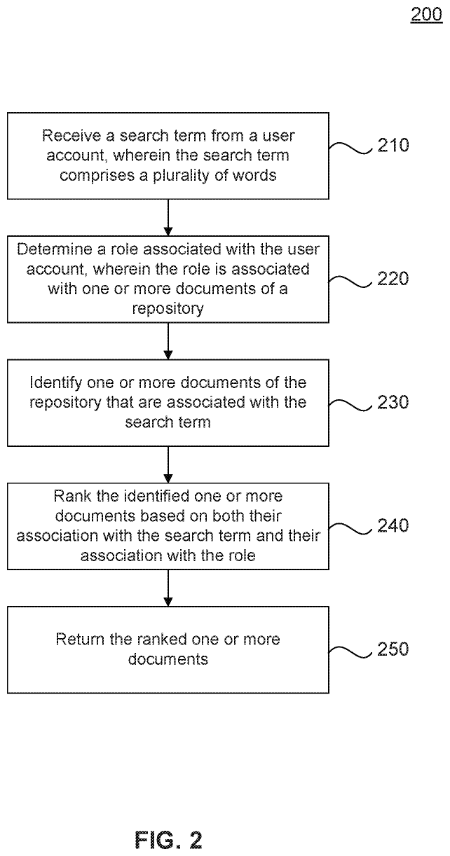

FIG. 2 is a flowchart 200 illustrating example operations of operations of a smart search and help system (SSHS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to the example embodiments,

In 210, a search term is received from a user account. For example, SSHS 102 may receive a search term 108 of one or more words from a user device 112. A user account 106 may be associated with the user device 112, for example a particular e-mail address, user ID, or mobile number. SSHS 102 may then associate search term 108 with user account 106.

In 220, a role associated with the user account is determined. For example, SSHS 102 may determine a role 116 of a user 114 based on the user account information 106. The role 116 may indicate a particular position within an organization. In an embodiment, the role 116 may correspond to a role 12.6 of one or more documents 104 in a repository 120.

In 230, one or more documents of the repository that are associated with the search term are identified. For example, SSHS 102 may search documents 104 for search term 108. In an embodiment, only those documents 104 that include a role 126 corresponding to role 116 may be searched.

In 240, the identified documents are ranked based on both their association with the search term and their association with the role. For example, a similarity between the roles 116, 126 may be used to increase a ranking 118 of a particular document in search results 110.

In 250, the ranked one or more documents are returned. For example, SSHS 102 may return results 1102 to an application 113 which may be operating on the user device 112 from which the search term 108 was received. The search results 110 may include links to one or more documents 104 or portions from repository 120.

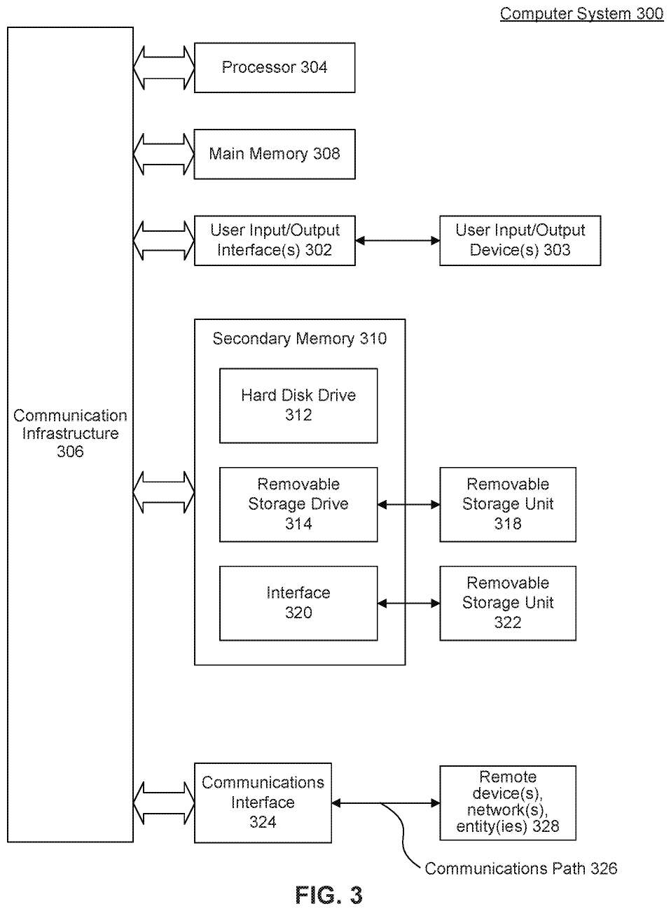

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving a search term from a user account, wherein the search term comprises a plurality of words;
determining a role associated with the user account, wherein the role is associated with one or more documents of a repository;
identifying one or more documents of the repository that are associated with the search term;
ranking the identified one or more documents based on both their association with the search term and their association with the role; and
returning the ranked one or more documents.

2. The method of claim 1, wherein the ranking comprises:
determining that a first one of the ranked documents includes a verified association to the search term, wherein a second one of the ranked documents does not include the verified association, and wherein the first ranked document is ranked higher than the second ranked document based on the verified association.

3. The method of claim 2, wherein the search term is associated with a product, and
wherein the first ranked document comprises a user manual of the product.

4. The method of claim 1, wherein the ranking comprises:
determining that the plurality of words include at least a first word and a second word;
calculating, for each of the identified documents, a distance between the first word and the second word within a context of each respective one of the identified documents; and
ranking the identified documents based on the distance, wherein a greater distance corresponds to a lower ranking.

5. The method of claim 1, wherein the ranking comprises:
determining a structure of the one or more identified documents;
identifying a location of the one or more words of the search term within the structure for a respective one of the identified documents; and
ranking the identified documents based on the identified location.

6. The method of claim 1, further comprising:
receiving the search term from a second user account associated with a second role; and
ranking the identified one or more documents based on both their association with the search term and their association with the second role, wherein the ranking based on the role differs from the ranking based on the second role.

7. The method of claim 1, wherein the identifying comprises:
computing a vector for the search term;
computing a vector for each of a plurality of the documents from the repository; and
comparing the vector for the search term to the vector for each of the documents to determine a similarity score.

8. The method of claim 7, further comprising:
ranking the plurality of documents based on the similarity score.

9. A system, comprising:
a memory; and
at least one processor coupled to the memory and configured to:
receive a search term from a user account, wherein the search term comprises a plurality of words;
determine a role associated with the user account, wherein the role is associated with one or more documents of a repository;
identify one or more documents of the repository that are associated with the search term;
rank the identified one or more documents based on both their association with the search term and their association with the role; and
return the ranked one or more documents.

10. The system of claim 9, wherein the at least one processor configured to rank is configured to:
determine that a first one of the ranked documents includes a verified association to the search term, wherein a second one of the ranked documents does not include the verified association, and wherein the first ranked document is ranked higher than the second ranked document based on the verified association.

11. The system of claim 10, wherein the search term is associated with a product, and
wherein the first ranked document comprises a user manual of the product.

12. The system of claim 9, wherein the at least one processor configured to rank is configured to:
determine that the plurality of words include at least a first word and a second word;
calculate, for each of the identified documents, a distance between the first word and the second word within a context of each respective one of the identified documents; and
rank the identified documents based on the distance, wherein a greater distance corresponds to a lower ranking.

13. The system of claim 9, wherein the at least one processor configured to rank is configured to:
determine a structure of the one or more identified documents:
identify a location of the one or more words of the search term within the structure for a respective one of the identified documents; and
rank the identified documents based on the identified location.

14. The system of claim 9, wherein the at least one processor is further configured to:
receive the search term from a second user account associated with a second role; and
rank the identified one or more documents based on both their association with the search term and their association with the second role, wherein the ranking based on the role differs from the ranking based on the second role.

15. The system of claim 9, wherein the at least one processor configured to identify is configured to:
compute a vector for the search term;
compute a vector for each of a plurality of the documents from the repository; and
compare the vector for the search term to the vector for each of the documents to determine a similarity score.

16. The system of claim 15, wherein the at least one processor is further configured to:
rank the plurality of documents based on the similarity score.

17. A non-transitory computer-readable device having instructions stored thereon that,
when executed by at least one computing device, cause the at least one computing device to perform operations comprising:
receiving a search term from a user account, wherein the search term comprises a plurality of words;
determining a role associated with the user account, wherein the role is associated with one or more documents of a repository;
identifying one or more documents of the repository that are associated with the search term;
ranking the identified one or more documents based on both their association with the search term and their association with the role; and
returning the ranked one or more documents.

18. The non-transitory computer-readable device of claim 17, wherein the ranking comprises:
determining that a first one of the ranked documents includes a verified association to the search term, wherein a second one of the ranked documents does not include the verified association, and wherein the first ranked document is ranked higher than the second ranked document based on the verified association.

19. The non-transitory computer-readable device of claim 18, wherein the search term is associated with a product, and wherein the first ranked document comprises a user manual of the product.

20. The non-transitory computer-readable device of claim 17, wherein the ranking comprises:
determining that the plurality of words include at least a first word and a second word;
calculating, for each of the identified documents, a distance between the first word and the second word within a context of each respective one of the identified documents; and
ranking the identified documents based on the distance, wherein a greater distance corresponds to a lower ranking.
